(19) United States
(12) Patent Application Publication
(10) Pub. No.: US 2026/0368518 A1
(43) Pub. Date: Nov. 19, 2026

(54) GENERATING RESPONSES TO QUERIES FROM RESPONSE TRAJECTORIES GENERATED USING GENERATIVE NEURAL NETWORKS

(71) Applicant: GDM Holding LLC, Mountain View, CA (US)

(72) Inventors: Gil Fidel, Petah Tikva (IL); Danny Karmon, Petah Tikva (IL)

(21) Appl. No.: 19/210,670

(22) Filed: May 16, 2025

(51) Int. Cl. G06N 3/08

(52) U.S. Cl. CPC G06N 3/08

(57) ABSTRACT

Methods, systems, and apparatus, including computer programs encoded on a computer storage medium, for generating responses to queries. In one aspect, a method comprises obtaining one or more queries and a respective response for each query; generating, for each query, one or more response trajectories; generating, for each query and for each response trajectory generated for the query, a respective snippet of code; generating, for each query and for each response trajectory generated for the query, a training example; and training a generative neural network on the training examples.

### BACKGROUND

This specification relates to processing inputs using neural networks to generate responses.

Neural networks are machine learning models that employ one or more layers of nonlinear units to predict an output for a received input. Some neural networks include one or more hidden layers in addition to an output layer. The output of each hidden layer is used as input to the next layer in the network, i.e., another hidden layer or the output layer. Each layer of the network generates an output from a received input in accordance with current values of a respective set of parameters.

### SUMMARY

This specification describes a system implemented as computer programs on one or more computers in one or more locations that generates responses to queries using generative neural networks. In particular, the system can use a generative neural network that has been trained on a training dataset that includes snippets of code to generate responses to queries.

In some examples, the system trains the generative neural network by using training examples where each training query is paired with a corresponding code snippet. This specific form of training data, where the target output is a code snippet representing the target computational logic for deriving a response, can, in some examples, guide the neural network to learn more robust representations of reasoning and task decomposition. This approach may offer a technical advantage by improving the logical consistency of the response trajectories generated by the neural network at inference time, even though code itself is not generated at inference. Moreover, the use of code snippets during training, which in some instances can be more token-efficient than full natural language response trajectories, can contribute to reduced computational load during the training phase for the generative neural network.

In general, one innovative aspect of the subject matter described in this specification can be embodied in methods that include the actions of obtaining one or more queries and a respective response for each query; generating, for each query, one or more response trajectories, wherein each response trajectory comprises, for each action in a sequence of actions for generating the respective response, natural language text describing the action; generating, for each query and for each response trajectory generated for the query, a respective snippet of code that, when executed, generates the respective response by following the sequence of actions specified by the response trajectory; generating, for each query and for each response trajectory generated for the query, a training example, wherein the training example comprises the respective snippet of code for the response trajectory and the query; and training a generative neural network on the training examples.

In some implementations, the method further includes obtaining an input query; and processing at least the input query and an instruction to generate an output response trajectory for the input query using the trained generative neural network.

In some implementations, the method further includes processing the output response trajectory to generate a response for the input query.

In some implementations, generating, for each query, one or more response trajectories comprises: processing an input comprising at least the query using a second generative neural network to generate the response trajectory.

In some implementations, the input further comprises the respective response and an instruction to generate, for each action in a sequence of actions for generating the respective response to the query, natural language text describing the action.

In some implementations, the second generative neural network is the generative neural network.

In some implementations, the generative neural network has been trained on a next token prediction task to determine trained values of parameters of the generative neural network.

In some implementations, processing the input comprising at least the query using the second generative neural network comprises processing the input in accordance with the trained values of the parameters of the generative neural network.

In some implementations, training the generative neural network on the training examples comprises determining updated values of the parameters of the generative neural network starting from the trained values of the parameters.

In some implementations, generating, for each query and for each response trajectory generated for the query, a respective snippet of code comprises: processing at least the response trajectory using a third generative neural network to generate the respective snippet of code.

In some implementations, processing at least the response trajectory using the third generative neural network comprises processing the response trajectory and an instruction to generate a snippet of code for the response trajectory using the third generative neural network.

In some implementations, the instruction further comprises one or more translation examples, each comprising an example response trajectory and an example snippet of code.

In some implementations, the third generative neural network is the generative neural network.

In some implementations, generating, for each query and for each response trajectory generated for the query, a respective snippet of code comprises: processing at least the response trajectory using a third generative neural network to generate a plurality of candidate snippets of code; and selecting the respective snippet of code from the candidate snippets of code based on one or more of: a respective code quality measure for each candidate snippet of code, or a respective measure of accuracy for each candidate snippet of code.

In some implementations, generating, for each query and for each response trajectory generated for the query, a training example comprises: including the query in a training input of the training example; and including the respective snippet of code for the response trajectory and the query in a target output of the training example.

In some implementations, one or more of the respective snippets of code comprises one or more code comments.

In general, another innovative aspect of the subject matter described in this specification can be embodied in methods that include the actions of receiving a query; and processing an input comprising at least the query using a generative neural network to generate a response to the query, wherein the generative neural network has been trained on a training dataset that comprises a plurality of training examples, wherein each training example comprises a respective snippet of code that, when executed, generates a respective response to a respective training query by following a sequence of actions, and wherein each respective snippet of code is generated from a corresponding response trajectory, wherein each corresponding response trajectory comprises, for each action in the sequence of actions, natural language text describing the action.

In some implementations, the input further comprises an instruction to generate a response trajectory for the query.

In some implementations, each training example comprises the respective training query.

Other implementations of these aspects include corresponding systems, apparatus, and computer programs, configured to perform the actions of the methods, encoded on computer storage devices.

The subject matter described in this specification can be implemented in particular embodiments so as to realize one or more of the following advantages.

The system described in this specification can generate accurate responses to queries for a variety of tasks. For example, the system can generate responses to queries for tasks such as natural language processing, planning, or multi-hop reasoning tasks by generating a response trajectory that includes, for each action in a sequence of actions for generating a response to the query, natural language text describing the action.

Some conventional systems for generating responses to queries by generating a response trajectory have been trained to generate response trajectories on training data that includes response trajectories. The system described in this specification generates responses to queries by generating a response trajectory while having been trained to generate snippets of code on training data that includes snippets of code. Each snippet of code, when executed, generates a respective response to a respective training query by following a sequence of actions. At inference, the system receives a query. The system processes an input that includes at least the query using a generative neural network, that has been trained on snippets of code, to generate a response for the query, e.g., by generating a response trajectory for the query. By using a generative neural network that has been trained to perform code generation to generate response trajectories at inference, the system can leverage the reasoning and task decomposition capabilities required for code generation learned during training of the generative neural network in order to generate response trajectories. These generated response trajectories can, as a result of this training approach, exhibit improved logical structure and a more accurate representation of the necessary steps to address the query. Training on code snippets, which can represent structured algorithmic thinking, may encourage the neural network to develop internal representations conducive to better task decomposition, potentially leading to more accurate and reliable outputs when generating natural language response trajectories for complex queries, such as those encountered in automated planning or multi-hop question answering systems. The system can thus improve the performance, e.g., accuracy, of the generative neural network. For example, the generative neural network can generate the correct response for a higher proportion of queries, compared to a conventionally trained generative neural network.

Thus, while the generative neural network is trained to generate a snippet of code given a query, after training and when performing inference, the generative neural network generates a response trajectory given a query, without generating a snippet of code for the query. In some cases, the system can generate a response from the response trajectory, without having to execute a snippet of code for the query, saving computing resources and computing time that would otherwise be required to execute the snippet of code.

Furthermore, in some examples, a snippet of code for a training query can include fewer tokens than are included in a response trajectory for the training query. Processing snippets of code during training requires fewer computational resources by the generative neural network compared to conventional training which requires processing response trajectories. This reduction in the number of tokens processed per training example can lead to a technical effect of, for instance, decreased memory usage on the training hardware (e.g., GPUs or TPUs) or faster processing of each training batch. Such efficiencies may allow for more extensive training epochs within a given computational budget or enable the training of larger, more capable generative neural network models on available hardware resources. Thus the system described in this specification can reduce the computational cost of training the generative neural network compared to a conventional system that is trained on response trajectories, while improving the performance of the generative neural network.

The system described in this specification can train the generative neural network to generate a snippet of code given a query. For example, the generative neural network can have been trained on a next token prediction task. The system can further train, e.g., through supervised fine-tuning, the generative neural network on training examples that include snippets of code in order to improve the performance, at inference, of the generative neural network in generating response trajectories that are responsive to queries.

In some examples, the system can generate the training examples. For example, the system can obtain one or more queries and a respective response for each query. The system can generate one or more response trajectories for each query. The system can generate a snippet of code for each response trajectory that, when executed, follows the sequence of actions specified by the response trajectory. The system can generate each training example for each query and for each response trajectory for the query that includes the query and a snippet of code generated for the response trajectory. The system can thus generate target snippets of code for training queries, without requiring existing training queries and ground-truth snippets of code. In some cases, obtaining ground-truth snippets of code can require manually generating snippets of code for training queries, which can be difficult or infeasible. In some cases, synthetic snippets of code that are generated using a generative neural network given a query include code that, when executed, directly prints out the final response without performing intermediate steps. The system described in this specification addresses this issue by generating target snippets of code that follow given response trajectories, ensuring that the snippets of code that are generated include code for intermediate steps. Generating training code snippets that explicitly include intermediate computational steps, derived from detailed response trajectories, can be particularly advantageous. For example, the training code snippets can guide the generative neural network during training to learn representations of more complete reasoning pathways. Consequently, at inference, the generated natural language response trajectories may be more detailed and less likely to omit critical intermediate logical steps, potentially improving their accuracy. In addition, the generated response trajectories can have improved utility for tasks where the traceability or verifiability of the reasoning process is beneficial, for example, in debugging decision-making processes or in providing explanations for a plan, e.g., generated using artificial intelligence (AI). Thus the system increases the number and quality of training examples available for training, resulting in improved training and performance of the generative neural network compared to a generative neural network trained on a limited amount of training data. For example, the generative neural network learns to perform intermediate thinking based on the intermediate steps of the snippets of code of the generated training examples, rather than directly predicting the response.

In some implementations, the system can generate the training examples using a prior checkpoint of the generative neural network to be trained or another instance of the generative neural network to be trained. For example, the system can generate a snippet of code for inclusion in a training example using a prior checkpoint of the generative neural network to be trained or another instance of the generative neural network to be trained. By making use of a single generative neural network, the system can reduce the amount of computing resources required to train and maintain the generative neural network compared to using multiple generative neural networks.

In some implementations, the system can generate the training examples for a training step using a prior checkpoint of the generative neural network being trained that is different at each training step. For example, the system can use the generative neural network resulting from a previous training step to generate the training examples for the training step. For example, the system can generate a snippet of code for inclusion in a training example using the generative neural network resulting from a previous training step, i.e., the generative neural network that has updated values of the parameters after being updated at the previous training step. For instance, by utilizing parameters from a checkpoint of the generative neural network that has already undergone some training (e.g., after a previous training step or epoch), the system can leverage this more developed generative neural network to generate the training data (e.g., the code snippets) for subsequent training steps. A generative neural network from a later checkpoint may, in some cases, be capable of producing more accurate, complex, or nuanced code snippets. Using higher-quality code snippets as targets in further training steps can create a virtuous cycle, progressively refining the generative neural network's capabilities. This iterative data generation and training process can be a technical means to bootstrap performance, potentially leading to a final generative neural network that exhibits enhanced accuracy or reasoning abilities in generating response trajectories, for example, by iteratively improving the generative neural network's grasp of complex procedural logic inherent in the code snippets. The system can thus further improve the performance of the generative neural network by training the generative neural network on higher quality training examples.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example generative neural network training system.

FIG. 2 shows an example response trajectory and an example snippet of code.

FIG. 3 is a diagram of an example process for training a generative neural network.

FIG. 4 is a flow diagram of an example process for training a generative neural network on training examples.

FIG. 5 is a flow diagram of an example process for generating a response to a query.

FIG. 6 shows the performance of an example generative neural network trained by a generative neural network training system.

Like reference numbers and designations in the various drawings indicate like elements.

### DETAILED DESCRIPTION

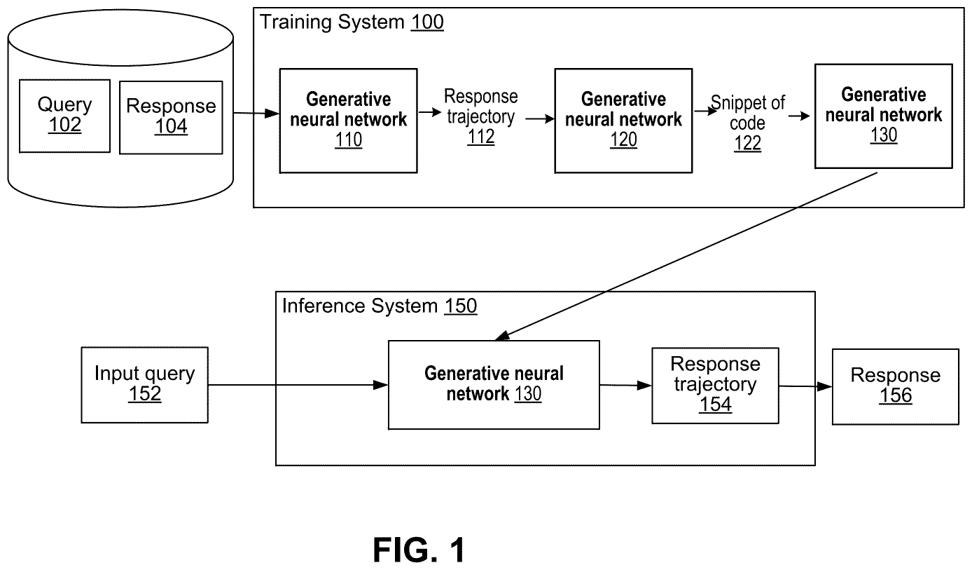

FIG. 1 shows an example generative neural network training system 100. The system 100 is an example of a system implemented as computer programs on one or more computers in one or more locations in which the systems, components, and techniques described below are implemented.

The training system 100 is a system that trains a generative neural network 130. The generative neural network 130 is configured to process a network input in accordance with the parameters of the generative neural network 130, e.g., the weights and optionally biases of the layers of the generative neural network 130, to generate a network output.

For example, the system 100 can train the generative neural network 130 to generate a response trajectory for performing a machine learning task given the network input. The task can include any appropriate task that can be decomposed into subtasks, also referred to as actions. For example, the task can be performed using a sequence of actions. In some examples, the task can benefit from decomposition into simpler subtasks. Some example tasks are described below. A response trajectory includes, for each action in a sequence of actions for performing the machine learning task, natural language text describing the action.

In some examples, an output for a task can be generated by performing a sequence of actions. In some examples, the sequence of actions can include actions performed by calling an external tool or by calling a generative neural network. In some examples, the sequence of actions can include reasoning steps. Each reasoning step includes an intermediate thought or logical step that contributes to generating the output for the task.

The sequence of actions can be represented, e.g., as natural language text describing the sequence of actions, or a snippet of code that, when executed, can follow the sequence of actions.

Some example tasks include a language processing, inference, or understanding task. For example, the input can include text and the task can include generating a sequence of text responsive to the input data. Example natural language processing, inference, or understanding tasks include an entailment task, a paraphrase task, a textual similarity task, a sentiment task, a sentence completion task, a grammaticality task, a commonsense task, a question answering task, a reading comprehension task, a reading comprehension with commonsense task, a coreference resolution task, a miscellaneous task, and the like. In some examples, the sequence of actions can include identifying the task, analyzing the input, extracting relevant information from the input, evaluating context from the input, or generating an output for the task. As an example, for a question answering task, the sequence of actions can include identifying information that is missing, selecting a source for information, retrieving information from the source, e.g., from the input or from an external database, or analyzing the retrieved information. As another example, for a sentiment task, the sequence of actions can include identifying phrases of the input that have positive or negative sentiment, or determining the overall tone of the input using the identified phrases.

In some examples, the input can include reasoning problems that can be decomposed into simpler subtasks, such as math problems or multi-hop reasoning problems. For example, for a math problem, the sequence of actions can include identifying the mathematical operations, determining the order of operations, evaluating expressions according to the order of operations, etc. As another example, for a multi-hop reasoning problem, the sequence of actions can include identifying the task, identifying relevant information from the input, assigning variables to information from the input, setting up a mathematical representation for the task, e.g., setting up an equation or system of equations, evaluating the mathematical representation for the task, etc.

As another example, the task can be a code generation task. For example, the input can include a text description of a desired piece of code or a snippet of computer code in a programming language. The output can include computer code, e.g., a snippet of code that is described by the input or a snippet of code that follows the input in a computer program. For example the input may represent words, wordpieces or characters in a first natural language and the output may represent instructions in a computer programming or markup language, or instructions for controlling an application program to perform a task, e.g., build a data item such as an image or web page. In some examples, the sequence of actions can include identifying the task, identifying operations for performing the task, generating code, e.g., conditions or variable assignments, for performing the operations, identifying existing functions, e.g., sorting functions, for performing the operations, combining the generated code and existing function into the snippet of code, etc.

As another example, the task can be a summarization task in which the outputs can include text summaries of, e.g., text, images, video, audio, etc. specified by the input. For example, for a summarization of text, the sequence of actions can include identifying key information from the text, selecting important elements to include in the summary, identifying information that is less important, and generating the summary, e.g., combining the important elements and omitting less important information, processing the important elements using a language model neural network to generate the summary, etc. As another example, for a summarization of a video, the sequence of actions can include obtaining a text description of content depicted in the video, e.g., using a video processing model, obtaining a transcript of speech in the video, e.g., using a speech processing model, obtaining a text description of audio depicted in the video, e.g., using an audio processing model, processing the text descriptions and transcript to identify scenes or segments of the video, generating a summary of each scene using the text descriptions and the transcript, e.g., using a language model neural network, combining the description of each scene in the summary, etc. As another example, for a summarization of an image, the sequence of actions can include obtaining a text description of content depicted in the image, e.g., using an image processing model, processing the text description to identify important information, generating a summary of the important information, e.g., using a language model neural network, etc. As another example, for a summarization of an audio signal, the sequence of actions can include obtaining a text description of the audio signal, e.g., using an audio processing model, obtaining a transcript of speech represented by the audio signal, e.g., using a speech processing model, processing the text description or transcript to identify important information, generating a summary of the important information, e.g., using a language model neural network, etc.

In some cases, the machine learning task is a multi-modal processing task that requires processing multi-modal data. In general, multi-modal data is a combination of two or more different types of data, e.g., two or more of audio data, image data, text data, or graph data. As another example the multi-modal data may comprise a combination of i) text data representing text in a natural language and ii) pixels of an image or of video or audio data representing values of an audio waveform. For example, the multi-modal processing task may correspond to any of the tasks previously described for any of the types of data making up the multi-modal combination. Examples of such tasks include image captioning, image generation, and so on. As an example, the task can include generating an image that depicts similar subjects as a given image. The multi-modal data can include an image and text that includes an instruction to generate an image that depicts similar subjects as the image. In some examples, the sequence of actions can include determining the subjects of the image, e.g., using an image processing model, generating an image generation prompt that includes the subjects, e.g., using a language model neural network, generating the image for the image generation prompt, e.g., using an image generation model, etc.

As another example, the machine learning task can be a robotic planning task. For example, the input can include data, e.g., text, image, etc., specifying a current state and a goal for an agent. The output can include data representing a sequence of steps for accomplishing the goal. The sequence of actions for generating the output can include identifying objectives for the goal, e.g., using a language model neural network or visual language model neural network (VLM), gathering information about the current state, generating options for performance by the robot at each step, selecting an option for each step, and generating data representing the sequence of steps for accomplishing the goal.

As another example, the machine learning task can be a trip or event planning task. For example, the input can include data, e.g., text, image, etc., specifying a goal. The output can include data representing a plan, e.g., an itinerary, for the goal. The sequence of actions for generating the output can include determining objectives for the goal, e.g., using a language model neural network or VLM, determining sub-events, determining deadlines, determining a timeline, and generating data representing the plan.

As another example, the machine learning task can be a resource allocation task, e.g., for allocating computational resources. For example, the input can include data specifying a goal for the allocation of resources and information about the computational resources, specifications, and components. The output can include data representing a resource management plan. The sequence of actions for generating the output can include determining objectives for the goal, identifying relevant information about the computational resources, specifications, and components, identifying issues, identifying future problems, identifying efficiencies, generating a strategy, and generating the resource management plan.

To train the generative neural network 130, the system 100 obtains a query 102 and a respective response 104 for the query 102.

The query 102 specifies a task to be performed. For example, the query 102 can include text that includes a question or an instruction to perform any of a variety of tasks. In some examples, the query 102 can include input data such as text data, audio data, image data, or video data, and text that includes a question or an instruction about the input data.

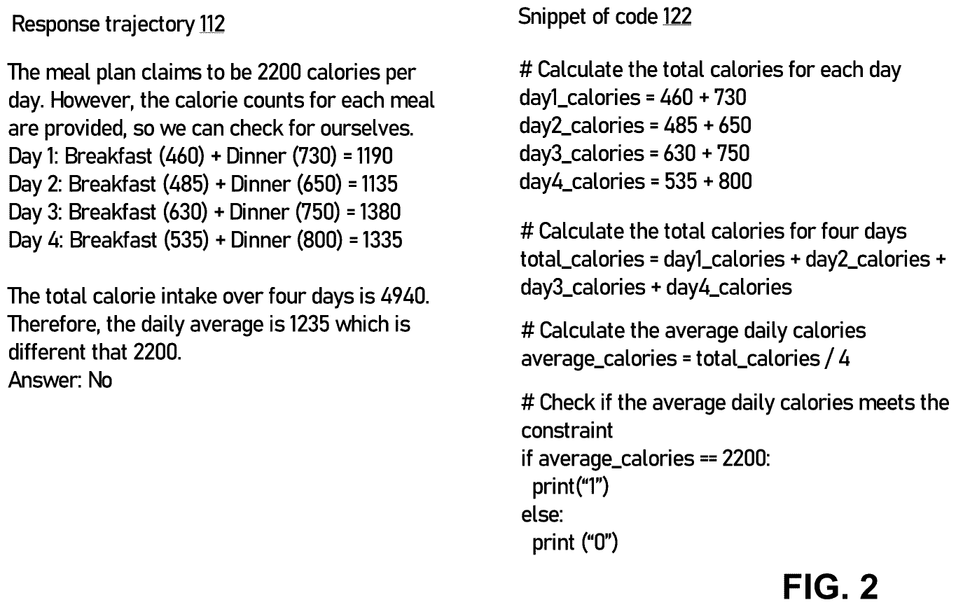

In the example of FIG. 1, the task can be a constraint satisfaction task. For example, the query 102 can include text that describes a meal plan with a calorie count per meal over multiple days, and a request to determine whether the meal plan meets a daily average calorie constraint. An example query 102 is described below with reference to FIG. 2.

In the example of FIG. 1, the response 104 for the query 102 indicates that the meal plan does not meet the daily average calorie constraint. For example, the response 104 can include “No” or “False.”

The system 100 generates one or more response trajectories such as the response trajectory 112 for the query 102. The response trajectory 112 includes, for each action in a sequence of actions for generating the respective response 104, natural language text describing the action. The response trajectory 112 is also referred to as a chain-of-thought trajectory.

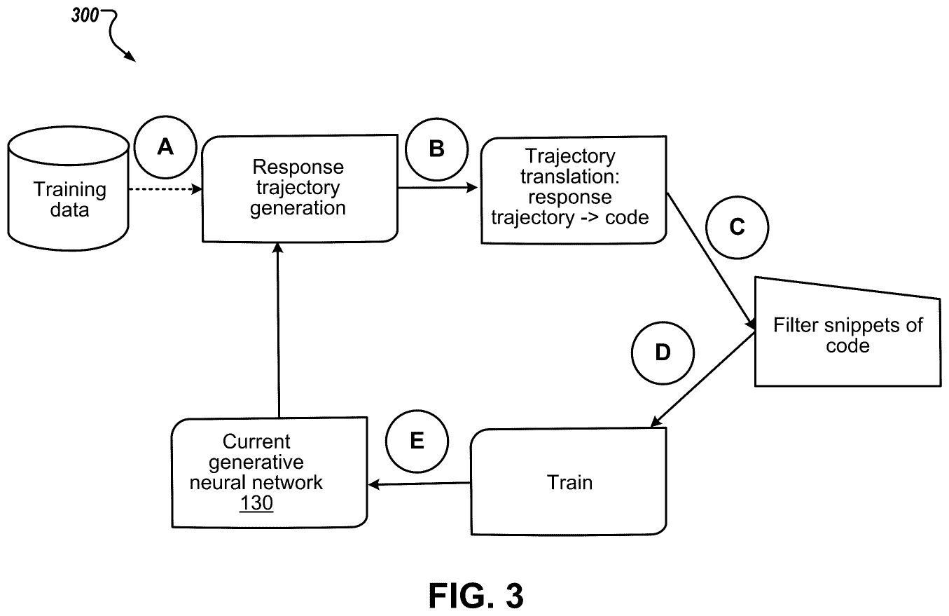

For example, the system 100 can generate the one or more response trajectories using a generative neural network 110. In some examples, the generative neural network 110 is the generative neural network 130, as described below with reference to FIG. 3.

In the example of FIG. 1, the response trajectory 112 includes natural language text describing actions for generating the response 104, such as calculating the total calories for each day, calculating the total calories over the four days, calculating the average calories per day, and determining whether the average calories per day is equal to the daily average calorie constraint. An example response trajectory 112 is described below with reference to FIG. 2.

The system 100 generates a snippet of code 122 for the response trajectory 112. The snippet of code 122 includes computer code that follows the response trajectory 112. For example, the snippet of code 122, when executed, can perform the sequence of actions specified by the response trajectory 112.

The snippet of code 122 includes text that represents computer code in a programming language. The snippet of code can include code that can be executed. For example, the snippet of code can be executed in an execution environment appropriate for the programming language of the snippet of code. Examples of programming languages include Python, Java, C++, etc. The snippet of code can include, for example, code comments, or programming logic such as function calls, external tool calls, if-else statements, loops, variable assignment, algorithms, etc. In some examples, the snippet of code can define one or more functions.

For example, the system 100 can generate the snippet of code 122 using a generative neural network 120. In some examples, the generative neural network 120 can be the generative neural network 110. In some examples, the generative neural network 120 can be the generative neural network 130, as described below with reference to FIG. 2.

In the example of FIG. 1, the actions for generating the response 104 specified by the response trajectory 112 include calculating the total calories for each day, calculating the total calories over the four days, calculating the average calories per day, and determining whether the average calories per day is equal to the daily average calorie constraint. The snippet of code 122 includes computer code that, when executed, generates the response 104 by following the sequence of actions. An example snippet of code 122 is described below with reference to FIG. 2.

The system 100 can generate a training example that includes the snippet of code 122 and the query 102. For example, the training example can include the snippet of code 122 as a target output and the query 102 as a training input.

The system 100 can train the generative neural network 130 on the training examples. For example, the system can train the generative neural network 130 using a machine learning training technique, e.g., a gradient descent with backpropagation training technique that uses a suitable optimizer, e.g., stochastic gradient descent, RMSprop, Adam optimizer, or Adafactor optimizer, to optimize an objective function that is specific to a next token prediction task. For example, the system can train the generative neural network 130 to optimize an objective function that, for each training example, measures an error (e.g., cross-entropy error) between (i) the snippet of code specified by the training example and (ii) the snippet of code generated by the generative neural network 130 for the query specified by the training example. The system 100 can thus determine updated values for the neural network parameters of the generative neural network 130.

After training, the training system 100 or a different inference system 150 deploys the trained generative neural network 130 on one or more computing devices to perform inference, i.e., to generate a response trajectory 154 for an input query 152.

For example, after training and when performing inference, the system 150 obtains the input query 152. In some examples, the system 150 receives at least part of the input query 152 from a user. For example, the system 150 can receive data for a task, e.g., data specifying a task, from a user through a user interface of a user device. In some examples, the system 150 includes an instruction to generate a response trajectory for responding to the task in the input query 152.

The system 150 processes the input query 152 using the trained generative neural network 130 to generate the response trajectory 154. The response trajectory 154 includes, for each action in a sequence of actions for generating the response 156, natural language text describing the action.

In some examples, the system 150 can generate a response 156 using the response trajectory 154. The response 156 can include, for example, audio data, image data, or video data that is responsive to the input query 152. The system 150 can generate the response 156 by taking the response trajectory 154 into account, e.g., by generating the response 156 conditioned on the response trajectory 154. For example, the system 150 can process the response trajectory 154 to generate the response 156, e.g., using the generative neural network 130.

In some examples, the system 150 can provide the response trajectory 154, the response 156, or both, for presentation to a user. For example, the system 150 can provide data representing the response 156 to a user device of the user.

Thus, while the generative neural network 130 is trained by the system 100 to generate a snippet of code given a query, after training and when performing inference, the generative neural network 130 generates a response trajectory given a query, without generating a snippet of code for the query. The system 150 can generate a response from the response trajectory, without having to execute a snippet of code for the query, saving computing resources and computing time. This potential saving in computing resources at inference time can be a significant technical advantage, particularly for applications requiring low-latency responses or for deployment on devices with limited computational power. For example, generating a textual response trajectory typically involves fewer floating-point operations per token than generating and executing a potentially complex code snippet that might involve numerical computations, library calls, or interpreter overhead. In some cases, this difference can result in measurably faster response generation, for instance, reducing inference latency by a factor that could be significant, e.g., in interactive applications. In some examples, the responses generated from response trajectories using the generative neural network 130 that has been trained to generate snippets of code are more accurate than responses generated using a generative neural network that has not been trained to generate snippets of code.

The generative neural network 110, the generative neural network 120, and the generative neural network 130 can have any appropriate architecture for generating an output responsive to an input. For example, the generative neural network 110, the generative neural network 120, and the generative neural network 130 can each include a language model neural network. Each language model neural network can have any of a variety of Transformer-based neural network architectures, e.g., encoder-only Transformer architectures, encoder-decoder Transformer architectures, decoder-only Transformer architectures, other attention-based architectures, and so on.

In general a Transformer-based architecture can be one which is characterized by having a succession of self-attention neural network layers. A self-attention neural network layer has an attention layer input for each element of the input and is configured to apply an attention mechanism over attention layer inputs to generate an attention layer output for each element of the input. There are many different attention mechanisms that may be used.

Examples of such architectures include those described in Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al., Language models are few-shot learners. arXiv preprint arXiv: 2005.14165, 2020; Aakanksha Chowdhery, et al., PaLM: Scaling Language Modeling with Pathways, arXiv preprint arXiv: 2204.02311; Rohan Anil, et al., Palm 2 technical report. arXiv preprint arXiv: 2305.10403, 2023, and Gemini Team, et al., Gemini: a family of highly capable multimodal models. arXiv preprint arXiv: 2312.11805, 2023.

Each language model neural network can be configured to generate output sequences made up of tokens from a vocabulary. In some examples, the vocabulary of tokens can include any of a variety of tokens that represent text symbols or other symbols. For example, the vocabulary of tokens can include one or more of characters, sub-words, words, punctuation marks, numbers, or other symbols that appear in a corpus of natural language text and/or computer code.

Additionally, or alternatively, the vocabulary of tokens can include tokens that can represent data other than text, such as images, videos, or audio. For example, the vocabulary of tokens can include image tokens that represent a discrete set of image patch embeddings of an image that can be generated by an image encoder neural network based on processing the image patches of the image. As another example, the vocabulary of tokens can include audio tokens that represent code vectors in a codebook of a quantizer, e.g., a residual vector quantizer.

As a particular example, each language model neural network can be an auto-regressive Transformer-based neural network that includes a plurality of layers that each apply a self-attention operation.

In particular, each language model neural network can be an auto-regressive neural network that auto-regressively generates the output sequence of tokens by generating each particular token in the output sequence conditioned on a current input sequence that includes (i) the input sequence followed by (ii) any tokens that precede the particular token in the output sequence.

More specifically, to generate a particular token, each language model neural network can process the current input sequence to generate a score distribution, e.g., a probability distribution, that assigns a respective score, e.g., a respective probability, to each token in the vocabulary of tokens. The language model neural network can then select, as the particular token, a token from the vocabulary using the score distribution. For example, the language model neural network can greedily select the highest-scoring token or can sample, e.g., using top-k sampling, nucleus sampling or another sampling technique, a token from the distribution.

Prior to being used for inference or being further trained as described in this specification, one or more of the generative neural networks can have been trained to determine trained values of parameters, e.g., as a baseline generative neural network. In some examples, the system 100 or the other system(s) trains the generative neural network on a next token prediction task, e.g., a task that requires predicting, given a current sequence of text tokens, the next token that follows the current sequence in the training data. In some examples, the system 100 or the other system(s) trains the generative neural network on a task that requires, for each given unlabeled text sequence in a training data set, predicting a text sequence that followed the given unlabeled text sequence in a corresponding document. As a particular example, the generative neural network can be trained on a maximum-likelihood objective on a large dataset of text, e.g., text that is publicly available from the Internet or another text corpus.

In some examples, the system 100 further trains the generative neural network 110 compared to the baseline generative neural network, e.g., after the generative neural network is trained to determine trained values of parameters, in order to determine further updates to one or more of the trained values. For example, the system 100 can train the generative neural network 110 on training examples that each include a training input that includes a training query and a corresponding target output that includes a response trajectory for the training query. For example, the system can train the generative neural network 110 to optimize an objective function that, for each training example, measures an error (e.g., cross-entropy error) between (i) the response trajectory specified by the training example and (ii) the response trajectory generated by the generative neural network 110 for the training query specified by the training example.

In some examples, the system 100 further trains the generative neural network 120. For example, the system 100 can train the generative neural network 120 on training examples that each include a training input that includes a training response trajectory and a corresponding target output that includes a snippet of code for the training response trajectory. For example, the system can train the generative neural network 120 to optimize an objective function that, for each training example, measures an error (e.g., cross-entropy error) between (i) the snippet of code specified by the training example and (ii) the snippet of code generated by the generative neural network 120 for the training response trajectory specified by the training example.

In some implementations, the generative neural network 110, the generative neural network 120, or both, can be a smaller neural network, e.g., having a smaller number of parameters, than the generative neural network 130, which can lead to improvements in computational efficiency as fewer computational resources are required to process inputs using a smaller neural network.

In some implementations, the generative neural network 110, the generative neural network 120, or both, can be a larger neural network, e.g., having a larger number of parameters, than the generative neural network 130. In some examples, the generative neural network 110 can generate more accurate response trajectories than would be generated using a smaller neural network. In some examples, the generative neural network 120 can generate more accurate snippets of code than would be generated using a smaller neural network. Thus the training examples can include more accurate target outputs.

In some implementations, the generative neural network 110, the generative neural network 120, or both, can be a neural network of a similar size, e.g., having a similar number of parameters, as the generative neural network 130.

In some implementations, the generative neural network 110, the generative neural network 120, or both, can be the same neural network as the generative neural network 130. In some examples, the generative neural network 110, the generative neural network 120, or both, can be a prior checkpoint of the generative neural network 130 or another instance of the generative neural network 130. A prior checkpoint of the generative neural network 130 has trained values of parameters, e.g., for the baseline generative neural network 130, or at a previous training step than the current generative neural network 130.

Using a prior checkpoint of the generative neural network 130 as the generative neural network 110, the generative neural network 120, or both, is described below with reference to FIG. 3.

FIG. 2 shows an example response trajectory 112 and an example snippet of code 122. The response trajectory 112 and the snippet of code 122 are generated for the query 102 by the system 100 as described above with reference to FIG. 1.

As a particular example, the query 102 can include text that describes a meal plan with a calorie count per meal over multiple days. In the example of FIG. 2, the calorie counts for Day 1 include “breakfast: 460” and “dinner: 730.” The calorie counts for Day 2 include “breakfast: 465” and “dinner: 650.” The calorie counts for Day 3 include “breakfast: 630” and “dinner: 750.” The calorie counts for Day 4 include “breakfast: 535” and “dinner: 800.” The query 102 also includes a request to determine whether the meal plan meets a daily average calorie constraint of calories.

In the example of FIG. 2, the response trajectory 112 generated by the generative neural network 110 can include:
The meal plan claims to be 2200 calories per day. However, the calorie counts for each meal are provided, so we can check for ourselves.
Day 1: Breakfast (460)+Dinner (730)=1190
Day 2: Breakfast (485)+Dinner (650)=1135
Day 3: Breakfast (630)+Dinner (750)=1380
Day 4: Breakfast (535)+Dinner (800)=1335
The total calorie intake over four days is 4940. Therefore, the daily average is 1235 which is different than 2200.
Answer: No

In the example of FIG. 2, the snippet of code 122 generated by the generative neural network 120 can include:

### Calculate the Total Calories for Each Day

day1_calories=460+730
day2_calories=485+650
day3_calories=630_750
day4_calories=535_800

### Calculate the Total Calories Over Four Days

total_calories=day1_calories+day2_calories+day3_calories+day4_calories

Calculate the Average Daily Calories average_calories=total_calories/4

### Check if the Average Daily Calories Meets the Constraint

if average_calories==2200:
   print(“1”)
else:
   Print(“0”)

In the example of FIG. 2, the snippet of code 122 includes one or more code comments. For example, the code comments in FIG. 2 are denoted by the comment delimiter “#”.

In some examples, the system further processes the output generated by the snippet of code to determine the response. In the example of FIG. 2, the snippet of code 122 prints “0” or “1.” The system can further process the output “0” or “1” to determine whether the response is “False” or “True,” e.g., according to a specified mapping that maps outputs printed by code snippets to natural language or structured responses.

FIG. 3 is a diagram of an example process 300 for training a generative neural network 130. For convenience, the process 300 will be described as being performed by a system of one or more computers located in one or more locations. For example, a generative neural network training system, e.g., the system 100 of FIG. 1, appropriately programmed, can perform the process 300.

The system can perform the steps A-E at each of one or more training steps. For example, the system can perform the steps A-E until the system determines that training is complete.

The system can determine whether training is complete using any of a variety of criteria. For example, the system can determine that training is complete after a pre-determined number of training steps. As another example, the system can determine that training is complete when a value of the objective function for the training step falls below a pre-determined threshold. As another example, the system can determine that training is complete when a difference between the value of the objective function for the current training step and a value of the objective function for a previous training step falls below a pre-determined threshold.

As part of step A, the system obtains training data. The training data can include one or more queries and a respective response for each query. An example query and example response are described above with reference to FIG. 1.

As part of step A, the system generates one or more response trajectories for each query. For example, for each response trajectory, the system can process an input that includes at least the query using a generative neural network to generate the response trajectory.

In some examples, the system can use a prior checkpoint of the generative neural network 130 that is a baseline checkpoint to generate the one or more response trajectories. For example, the baseline checkpoint of the generative neural network 130 can have been trained on a next token prediction task to determine trained values of parameters of the generative neural network 130. Thus the system can process the input using the generative neural network 130 in accordance with the trained values of the parameters.

In some examples, the prior checkpoint of the generative neural network 130 can have updated values of the parameters from the baseline checkpoint. For example, the prior checkpoint of the generative neural network 130 can be the current generative neural network 130 that has updated values of the parameters for a previous training step.

In some examples, the system generates multiple candidate response trajectories for each query. In these examples, the system filters the candidate response trajectories to select the one or more response trajectories. For example, the system can select the response trajectories based on a respective measure of accuracy for each response trajectory.

The measure of accuracy can measure the quality of the candidate response generated using the candidate response trajectory, e.g., whether the response trajectory includes the target response, or how similar the candidate response generated using the candidate response trajectory is to the target response. For example, the system can determine a measure of accuracy by comparing, e.g., string comparison, semantic comparison, or embedding difference, the candidate response generated using the candidate response trajectory with the target response. In some examples, the system can process the candidate response trajectory to generate the candidate response, e.g., using a language model neural network to extract the candidate response. The system can select one or more response trajectories with a highest accuracy from the candidate response trajectories.

For example, the system can determine the measure of accuracy based on embedding difference. For example, the system can process the candidate response to generate a candidate response embedding. The system can process the target response using the embedding model to generate a target response embedding. The system can determine a distance between the candidate response embedding and the target response embedding. The system can determine the measure of accuracy based on the distance between the candidate response embedding and the target response embedding. An embedding refers to an ordered collection of numerical values, e.g., a vector, matrix, or other tensor of numerical values.

As part of step B, the system generates a snippet of code for each query and for each response trajectory. For example, for each query and for each response trajectory, the system can process an input that includes at least the response trajectory using a generative neural network to generate the snippet of code.

In some examples, the system can use a prior checkpoint of the generative neural network 130 that is a baseline checkpoint to generate the snippets of code. For example, the baseline checkpoint of the generative neural network 130 can have been trained on a next token prediction task to determine trained values of parameters of the generative neural network 130. Thus the system can process the input using the generative neural network 130 in accordance with the trained values of the parameters.

In some examples, the prior checkpoint of the generative neural network 130 can have updated values of the parameters from the baseline checkpoint. For example, the prior checkpoint of the generative neural network 130 can be the current generative neural network 130 that has updated values of the parameters for a previous training step, i.e., updated values of the parameters after being updated at the previous training step.

In some examples, the system generates multiple candidate snippets of code for each query and for each response trajectory. In these examples, as part of step C, the system filters the snippets of code to select the snippet of code. For example, the system can select the snippet of code based on one or more of: a respective code quality measure for each candidate snippet of code, or a respective measure of accuracy for each candidate snippet of code. In some examples, the system can select the snippet of code based on a combination, e.g., a weighted combination, of the respective code quality measure or the respective measure of accuracy, for each candidate snippet of code. For example, the system can rank the candidate snippets of code according to the respective code quality measures, the respective measures of accuracy, or both. The system can select the top-ranked candidate snippet of code.

By selecting code snippets that are syntactically correct and verifiably produce the correct response, the system can reduce the noise in the training data. Training the generative neural network 130 on such validated code snippets can improve the learning efficiency and reduce the likelihood of the generative neural network learning spurious or incorrect patterns, which could otherwise degrade the quality of the response trajectories generated at inference. For instance, a code quality measure that penalizes overly complex code (e.g., high cyclomatic complexity) for a simple task might guide the selection towards more canonical or efficient code representations, which can be beneficial for the model to learn generalizable problem-solving strategies.

The code quality measure can measure the quality of the candidate snippet of code. In some examples, the code quality measure can measure a combination, e.g., a weighted combination, of aspects of quality of the candidate snippet of code.

In some examples, the code quality measure can measure whether the candidate snippet of code includes code that is syntactically correct or has errors. For example, the system can determine a code quality measure that measures whether the candidate snippet of code includes code that is syntactically correct by processing the snippet of code using a syntax checker.

In some examples, the system can determine a code quality measure that measures whether the candidate snippet of code includes code that has errors by processing the candidate snippet of code using a static analysis tool, e.g., a lint tool.

In some examples, the code quality measure can measure whether the candidate snippet of code is able to be executed successfully, or whether the snippet of code, when executed, crashes or raises an exception. For example, the system can cause the candidate snippet of code to be executed in an execution environment appropriate for the programming language of the candidate snippet of code.

In some examples, the code quality measure can measure adherence of the candidate snippet of code to code style guidelines or best practices. For example, the system can process the candidate snippet of code using a static analysis tool, e.g., a lint tool.

In some examples, the code quality measure can measure the length of the candidate snippet of code, e.g., number of lines of code, number of characters, number of code comments, etc.

In some examples, the code quality measure can measure code complexity of the candidate snippet of code. For example, the system can process the candidate snippet of code to determine code metrics for the candidate snippet of code, such as cyclomatic complexity.

In some examples, the code quality measure can measure whether the candidate snippet of code adheres to task-specific heuristics. For example, for a math-related task, the code quality measure can measure whether the snippet of code uses a math library. In some examples, the system can determine the type of task using one or more classifiers that are configured to classify the type of task for a given query. In some examples, the types of tasks can include predefined tasks such as math, coding, information retrieval, etc. In some examples, the types of tasks can be binary, e.g., math-related or not math-related. In these examples, the system can include a classifier for multiple types of tasks.

The measure of accuracy can measure the quality of the candidate response generated upon execution of the candidate snippet of code, e.g., whether the candidate snippet of code, when executed, generates the target response, or how similar the candidate response generated upon execution of the candidate snippet of code is to the target response. For example, the system can determine a measure of accuracy that measures how similar the response generated upon execution of the candidate snippet of code is to the target response by comparing, e.g., string comparison, semantic comparison, or embedding difference, the candidate response generated upon execution of the candidate snippet of code with the target response. In some examples, the system can execute the candidate snippet of code to generate the candidate response. For example, the system can cause the candidate snippet of code to be executed in an execution environment appropriate for the programming language of the candidate snippet of code.

As part of step D, the system can further train the generative neural network 130 using one or more of the snippets of code generated for each query for the training step. For example, the system can generate, for each query and for each response trajectory generated for the query, a training example by including the query in a training input of the training example. The system can include the respective snippet of code for the response trajectory and the query in a target output of the training example. The system can further train, e.g., through supervised fine-tuning (SFT), the generative neural network 130 using the training examples. For example, the system can fine-tune the generative neural network 130 to optimize an objective function, e.g., a cross-entropy objective function, or another objective function, that evaluates, for each training example, a difference between (i) the snippet of code specified by the training example and (ii) the snippet of code generated by the generative neural network for the training example. As a particular example, the cross-entropy objective function can be a combination, e.g., sum or average, of cross-entropy losses between the tokens in (i) the snippet of code specified by the training example and (ii) the snippet of code generated by the generative neural network for the training example.

Training the generative neural network 130 on these code snippets, which are themselves derived from natural language response trajectories, leverages the structured and unambiguous nature of code as a learning signal. Code, by its nature, often makes explicit the logical steps and control flow required to achieve a result. By learning to generate such structured representations, the neural network may develop more robust internal representations of reasoning and task decomposition. These learned representations can then be effectively applied when the network is tasked, at inference, with generating natural language response trajectories, potentially leading to response trajectories that are more logically sound, complete, and aligned with the underlying problem-solving steps, which can be a technical improvement in the quality of the system's output, e.g., as improved performance of the generative neural network.

The system can thus determine updated values for the parameters of the generative neural network 130. At the first training step, the system can determine updated values for the parameters starting from the trained values of the parameters of the baseline generative neural network. At each subsequent training step, the system can determine updated parameters starting from the updated values for the parameters determined for the preceding training step.

As part of step E, the system can output data representing the current generative neural network 130. For example, the system can determine whether training is complete. If the system determines that training is complete, the system can return the current generative neural network 130. The system can use the current generative neural network 130 as part of the inference system 150 described above with reference to FIG. 1.

If the system determines that training is not complete, the system can continue to a next training step, e.g., return to step A.

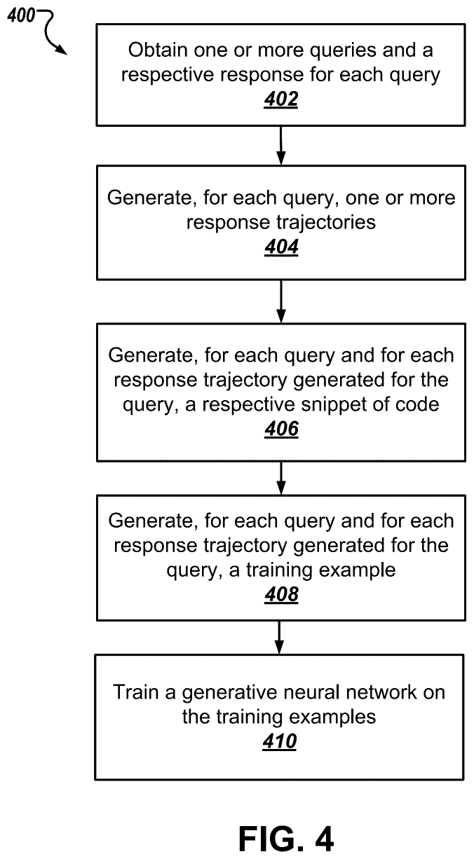

FIG. 4 is a flow diagram of an example process 400 for training a generative neural network on training examples. For convenience, the process 400 will be described as being performed by a system of one or more computers located in one or more locations. For example, a generative neural network training system, e.g., the system 100 of FIG. 1, appropriately programmed, can perform the process 400.

The system obtains one or more queries and a respective response for each query (step 402). Each query can specify a task. In some examples, the query can include data, e.g., text data, audio data, image data, video data, etc., for the task. The respective response for each query can include data, e.g., text data, audio data, image data, video data, etc., that is responsive to the query.

The system generates, for each query, one or more response trajectories (step 404). Each response trajectory includes, for each action in a sequence of actions for generating the respective response, natural language text describing the action.

For example, to generate each response trajectory, the system can process an input that includes at least the query using a second generative neural network to generate the response trajectory. In some examples, the input can include the respective response for the query and an instruction to generate, for each action in a sequence of actions for generating the respective response to the query, natural language text describing the action.

In some implementations, the second generative neural network is a different neural network than the generative neural network being trained. In some implementations, the second generative neural network is the generative neural network being trained, as described with reference to FIG. 3.

In some examples, the system generates multiple candidate response trajectories for each query. The system can select the one or more response trajectories from the candidate response trajectories based on a respective measure of accuracy for each response trajectory, as described above with reference to FIG. 3.

The system generates, for each query and for each response trajectory generated for the query, a respective snippet of code (step 406). Each respective snippet of code includes computer code that, when executed, generates the respective response for the query by following the sequence of actions specified by the response trajectory.

For example, the system can process at least the response trajectory using a third generative neural network to generate the snippet of code. In some examples, the system can process the response trajectory and an instruction to generate a snippet of code for the response trajectory using the third generative neural network. In some examples, the instruction can include one or more translation examples that each include an example response trajectory and an example snippet of code for the example response trajectory.

By generating a snippet of code that, when executed, follows the sequence of actions specified by the response trajectory, the system can generate high quality snippets of code. For example, the system can ensure that the snippets of code that are included in training examples include code that performs intermediate steps when executed. The generative neural network being trained can thus learn to generate code for intermediate steps, rather than code that directly generates an output when executed.

Ensuring intermediate steps are encoded in the training snippets can encourage the generative neural network to learn a more granular and decomposable model of task execution. For example, if a task involves multiple calculations or logical inferences, training on code that explicitly performs each intermediate step (rather than directly outputting a final answer) may help the model to better understand and replicate these multi-step reasoning processes when generating natural language response trajectories at inference. This can result in trajectories that are more transparent and potentially more accurate or reliable for queries.

In some implementations, the third generative neural network is a different generative neural network than the generative neural network being trained. In some implementations, the third generative neural network is the generative neural network being trained, as described with reference to FIG. 3.

In some examples, the system generates multiple candidate snippets of code for each query and for each response trajectory. The system can select the respective snippet of code for each query and for each response trajectory from the candidate snippets of code based on one or more of: a respective code quality measure for each candidate snippet of code, or a respective measure of accuracy for each candidate snippet of code, as described above with reference to FIG. 3.

In some examples, the system can cause the snippet of code to be executed. For example, the system can determine whether the snippet of code, when executed, generates the respective response for the query. For example, the system can compare whether the snippet of code, when executed, generates an equivalent, e.g., has a similarity that meets a threshold similarity, response to the respective response. In response to determining that the snippet of code, when executed, generates the respective response for the query, the system can proceed to step 408. In response to determining that the snippet of code, when executed, does not generate the respective response for the query, the system can repeat step 406 to generate a new snippet of code.

The system generates, for each query and for each response trajectory generated for the query, a training example (step 408). The training example includes the respective snippet of code for the response trajectory and the query. For example, the training example can include the query as a training input and the respective snippet of code for the response trajectory as the target output.

The system trains a generative neural network on the training examples (step 410). For example, the system can train the generative neural network to optimize an objective function that, for each training example, measures an error (e.g., cross-entropy error) between each token in (i) the snippet of code specified by the training example and (ii) the snippet of code generated by the generative neural network for the training example.

In some examples, the system performs the step 410 over a sequence of training steps. For example, at step 402, the system can obtain multiple queries and a respective response for each query. The system performs steps 404-408 to generate multiple training examples. At each training step, the system can determine to update values for parameters of the generative neural network using one or more training examples for the training step out of the multiple training examples.

In some examples, the system trains the generative neural network by performing the process 400 at each of a sequence of training steps, as described above with reference to FIG. 3. For example, at step 402, the system can obtain one or more queries and a respective response for each query for the training step. The system performs steps 404-408 to generate training examples for the training step. The system performs step 410 to train the generative neural network using the training examples for the training step.

In some examples, the second generative neural network, the third generative neural network, or both, can be the generative neural network being trained. For example, the second generative neural network, the third generative neural network, or both, can be a prior training checkpoint of the generative neural network. The prior checkpoint can include, for example, the generative neural network resulting from any previous training step, or the baseline generative neural network that has not been further trained using the process 400.

In some examples, at one or more training steps, the second generative neural network, the third generative neural network, or both, can be a different prior training checkpoint of the generative neural network than was used in one or more other training steps. For example, the system can use a different prior training checkpoint of the generative neural network at a regular interval of training steps, e.g., each training step, every two training steps, etc. The different prior training checkpoint can include, e.g., the generative neural network at the immediately preceding training step, the generative neural network at two training steps before, etc. By using a further trained version of the generative neural network to generate training examples for training the generative neural network, the system can generate higher quality training examples for training the generative neural network. The system can thus further improve the performance of the generative neural network.

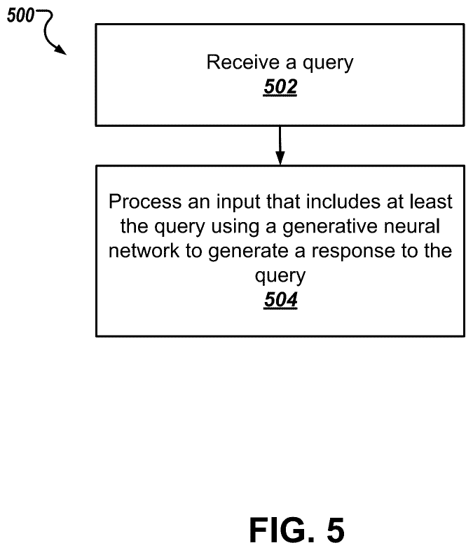

In some examples, after training the generative neural network, the system can perform inference using the trained generative neural network as described below with reference to FIG. 5. For example, the system can receive an input query. The system can process at least the input query and an instruction to generate an output response trajectory for the input query using the trained generative neural network. In some examples, the system can process the output response trajectory to generate a response for the input query.

FIG. 5 is a flow diagram of an example process 500 for generating a response to a query. For convenience, the process 500 will be described as being performed by a system of one or more computers located in one or more locations. For example, a response generation system, e.g., the inference system 150 of FIG. 1, appropriately programmed, can perform the process 500.

The system receives a query (step 502). The query can include data specifying a task. For example, the query can include natural language text.

The system processes an input that includes at least the query using a generative neural network to generate a response to the query (step 504). For example, the system can process the input using the generative neural network to generate a response trajectory for the query. The system can generate the response using the generated response trajectory, e.g., conditioned on the generated response trajectory. In some examples, the input further includes an instruction to generate a response trajectory for the query.

The generative neural network can have been trained as described above with reference to FIGS. 1-4. For example, the generative neural network can have been trained on a training dataset that includes multiple training examples that each include a respective snippet of code that, when executed, generates a respective response to a respective training query by following a sequence of actions. In some examples, one or more of the snippets of code include one or more code comments.

Each respective snippet of code can have been generated from a corresponding response trajectory that includes for each action in the sequence of actions, natural language text describing the action. In some examples, each training example includes the respective training query.

While the generative neural network generates a response trajectory for the query, the generative neural network is trained on snippets of code. As described above with reference to FIGS. 1-4, the snippets of code are generated from training response trajectories that are high-quality. The generative neural network is thus trained on high-quality snippets of code. At inference, while the generative neural network does not generate a snippet of code for a given query, the system can leverage the reasoning and task decomposition capabilities required for code generation learned during training of the generative neural network in order to generate high-quality response trajectories for the query.

The generation of a response trajectory, rather than directly executable code, at inference time can offer technical advantages in terms of safety and interpretability in certain applications. For instance, a natural language response trajectory can be reviewed by a human operator or a secondary validation system before any actions implied by the trajectory are taken in a real-world technical system. Furthermore, the computational cost of generating this textual trajectory may be lower and more predictable than executing arbitrary code, potentially making the system more suitable for resource-constrained environments or real-time interactive applications where predictable latency is a concern.

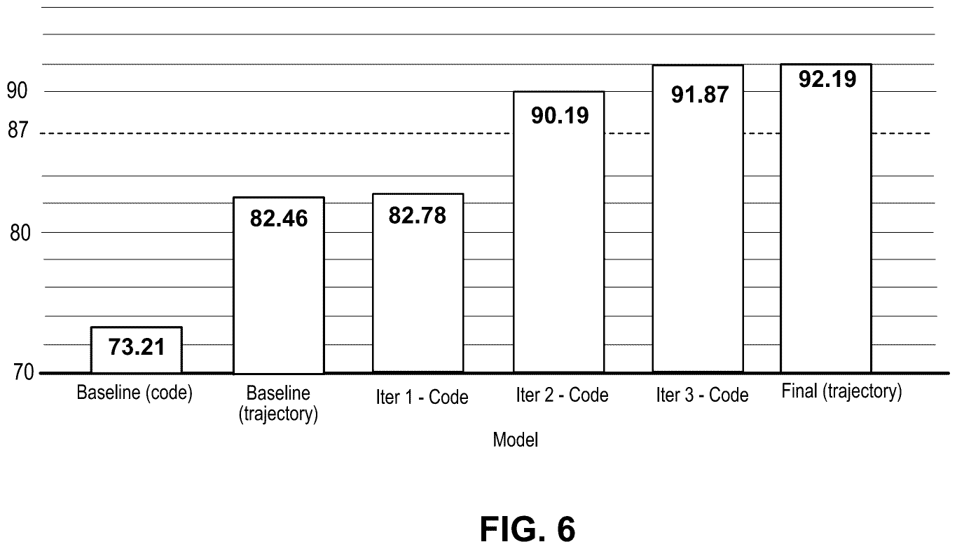

FIG. 6 shows the performance of an example generative neural network trained by a generative neural network training system. In particular, FIG. 6 shows the performance of an example generative neural network in terms of accuracy of the response generated using the response trajectory generated by the generative neural network.

As can be seen from FIG. 6, a generative neural network trained as described in this specification (“Iter 1-Code” for the generative neural network after the first training step, “Iter 2-Code” for the generative neural network after the second training step, “Iter 3-Code” for the generative neural network after the third training step, and “Final (trajectory)” for the generative neural network after the last training step), has a higher accuracy than conventionally trained generative neural networks (“Baseline (code)” and “Baseline (trajectory)”). For example, “Iter1-Code”, “Iter 2-Code”, and “Iter 3-Code” refer to the accuracy of responses generated by executing a snippet of code generated by the generative neural network at the respective training steps. “Final (trajectory)” refers to the accuracy of responses generated by conditioning on the reasoning trajectory generated by the generative neural network after the last training step. “Baseline (code)” refers to the accuracy of responses generated by executing a snippet of code generated by a conventionally trained generative neural network. “Baseline (trajectory)” refers to the accuracy of responses generated using a response trajectory generated by a conventionally trained generative neural network. FIG. 6 shows that the generative neural network trained as described in this specification can generate response trajectories from which responses of higher accuracy are generated, compared to responses generated from snippets of code or response trajectories generated using conventionally trained generative neural networks (“Baseline (code)” and “Baseline (trajectory)”).

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

In addition to the embodiments described above, the following embodiments are also innovative:

Embodiment 1 is a computer-implemented method comprising: obtaining one or more queries and a respective response for each query; generating, for each query, one or more response trajectories, wherein each response trajectory comprises, for each action in a sequence of actions for generating the respective response, natural language text describing the action; generating, for each query and for each response trajectory generated for the query, a respective snippet of code that, when executed, generates the respective response by following the sequence of actions specified by the response trajectory; generating, for each query and for each response trajectory generated for the query, a training example, wherein the training example comprises the respective snippet of code for the response trajectory and the query; and training a generative neural network on the training examples.

Embodiment 2 is the method of embodiment 1, further comprising: obtaining an input query; and processing at least the input query and an instruction to generate an output response trajectory for the input query using the trained generative neural network.

Embodiment 3 is the method of embodiment 2, further comprising processing the output response trajectory to generate a response for the input query.

Embodiment 4 is the method of any one of embodiments 1-3, wherein generating, for each query, one or more response trajectories comprises: processing an input comprising at least the query using a second generative neural network to generate the response trajectory.

Embodiment 5 is the method of embodiment 4, wherein the input further comprises the respective response and an instruction to generate, for each action in a sequence of actions for generating the respective response to the query, natural language text describing the action.

Embodiment 6 is the method of any one of embodiments 4-5, wherein the second generative neural network is the generative neural network.

Embodiment 7 is the method of embodiment 6, wherein the generative neural network has been trained on a next token prediction task to determine trained values of parameters of the generative neural network.

Embodiment 8 is the method of embodiment 7, wherein processing the input comprising at least the query using the second generative neural network comprises processing the input in accordance with the trained values of the parameters of the generative neural network.

Embodiment 9 is the method of embodiment 8, wherein training the generative neural network on the training examples comprises determining updated values of the parameters of the generative neural network starting from the trained values of the parameters.

Embodiment 10 is the method of any one of embodiments 1-9, wherein generating, for each query and for each response trajectory generated for the query, a respective snippet of code comprises: processing at least the response trajectory using a third generative neural network to generate the respective snippet of code.

Embodiment 11 is the method of embodiment 10, wherein processing at least the response trajectory using the third generative neural network comprises processing the response trajectory and an instruction to generate a snippet of code for the response trajectory using the third generative neural network.

Embodiment 12 is the method of embodiment 11, wherein the instruction further comprises one or more translation examples, each comprising an example response trajectory and an example snippet of code.

Embodiment 13 is the method of any one of embodiments 10-12, wherein the third generative neural network is the generative neural network.

Embodiment 14 is the method of any one of embodiments 1-9, wherein generating, for each query and for each response trajectory generated for the query, a respective snippet of code comprises: processing at least the response trajectory using a third generative neural network to generate a plurality of candidate snippets of code; and selecting the respective snippet of code from the candidate snippets of code based on one or more of: a respective code quality measure for each candidate snippet of code, or a respective measure of accuracy for each candidate snippet of code.

Embodiment 15 is the method of any one of embodiments 1-14, wherein generating, for each query and for each response trajectory generated for the query, a training example comprises: including the query in a training input of the training example; and including the respective snippet of code for the response trajectory and the query in a target output of the training example.

Embodiment 16 is the method of any one of embodiments 1-15, wherein one or more of the respective snippets of code comprises one or more code comments.

Embodiment 17 is a computer-implemented method comprising: receiving a query; and processing an input comprising at least the query using a generative neural network to generate a response to the query, wherein the generative neural network has been trained on a training dataset that comprises a plurality of training examples, wherein each training example comprises a respective snippet of code that, when executed, generates a respective response to a respective training query by following a sequence of actions, and wherein each respective snippet of code is generated from a corresponding response trajectory, wherein each corresponding response trajectory comprises, for each action in the sequence of actions, natural language text describing the action.

Embodiment 18 is the method of embodiment 17, wherein the input further comprises an instruction to generate a response trajectory for the query.

Embodiment 19 is the method of any one of embodiments 17-18, wherein each training example comprises the respective training query.

Embodiment 20 is a system comprising one or more computers and one or more storage devices communicatively coupled to the one or more computers, wherein the one or more storage devices store instructions that, when executed by the one or more computers, cause the one or more computers to perform operations of the respective method of any of embodiments 1-19.

Embodiment 21 is one or more non-transitory computer storage media encoded with computer program instructions that when executed by one or more computers cause the one or more computers to perform operations of the respective method of any of embodiments 1-19.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
obtaining one or more queries and a respective response for each query;
generating, for each query, one or more response trajectories, wherein each response trajectory comprises, for each action in a sequence of actions for generating the respective response, natural language text describing the action;
generating, for each query and for each response trajectory generated for the query, a respective snippet of code that, when executed, generates the respective response by following the sequence of actions specified by the response trajectory;
generating, for each query and for each response trajectory generated for the query, a training example, wherein the training example comprises the respective snippet of code for the response trajectory and the query; and
training a generative neural network on the training examples.

2. The method of claim 1, further comprising:
obtaining an input query; and
processing at least the input query and an instruction to generate an output response trajectory for the input query using the trained generative neural network.

3. The method of claim 2, further comprising processing the output response trajectory to generate a response for the input query.

4. The method of claim 1, wherein generating, for each query, one or more response trajectories comprises:
processing an input comprising at least the query using a second generative neural network to generate the response trajectory.

5. The method of claim 4, wherein the input further comprises the respective response and an instruction to generate, for each action in a sequence of actions for generating the respective response to the query, natural language text describing the action.

6. The method of claim 4, wherein the second generative neural network is the generative neural network.

7. The method of claim 6, wherein the generative neural network has been trained on a next token prediction task to determine trained values of parameters of the generative neural network.

8. The method of claim 7, wherein processing the input comprising at least the query using the second generative neural network comprises processing the input in accordance with the trained values of the parameters of the generative neural network.

9. The method of claim 8, wherein training the generative neural network on the training examples comprises determining updated values of the parameters of the generative neural network starting from the trained values of the parameters.

10. The method of claim 1, wherein generating, for each query and for each response trajectory generated for the query, a respective snippet of code comprises:
processing at least the response trajectory using a third generative neural network to generate the respective snippet of code.

11. The method of claim 10, wherein processing at least the response trajectory using the third generative neural network comprises processing the response trajectory and an instruction to generate a snippet of code for the response trajectory using the third generative neural network.

12. The method of claim 11, wherein the instruction further comprises one or more translation examples, each comprising an example response trajectory and an example snippet of code.

13. The method of claim 10, wherein the third generative neural network is the generative neural network.

14. The method of claim 1, generating, for each query and for each response trajectory generated for the query, a respective snippet of code comprises:
processing at least the response trajectory using a third generative neural network to generate a plurality of candidate snippets of code; and
selecting the respective snippet of code from the candidate snippets of code based on one or more of: a respective code quality measure for each candidate snippet of code, or a respective measure of accuracy for each candidate snippet of code.

15. The method of claim 1, wherein generating, for each query and for each response trajectory generated for the query, a training example comprises:
including the query in a training input of the training example; and
including the respective snippet of code for the response trajectory and the query in a target output of the training example.

16. The method of claim 1, wherein one or more of the respective snippets of code comprises one or more code comments.

17. A computer-implemented method comprising:
receiving a query; and
processing an input comprising at least the query using a generative neural network to generate a response to the query, wherein the generative neural network has been trained on a training dataset that comprises a plurality of training examples, wherein each training example comprises a respective snippet of code that, when executed, generates a respective response to a respective training query by following a sequence of actions, and wherein each respective snippet of code is generated from a corresponding response trajectory, wherein each corresponding response trajectory comprises, for each action in the sequence of actions, natural language text describing the action.

18. The method of claim 17, wherein the input further comprises an instruction to generate a response trajectory for the query.

19. The method of claim 17, wherein each training example comprises the respective training query.

20. A system comprising:
one or more computers; and
one or more storage devices communicatively coupled to the one or more computers, wherein the one or more storage devices store instructions that, when executed by the one or more computers, cause the one or more computers to perform operations comprising:
obtaining one or more queries and a respective response for each query;
generating, for each query, one or more response trajectories, wherein each response trajectory comprises, for each action in a sequence of actions for generating the respective response, natural language text describing the action;
generating, for each query and for each response trajectory generated for the query, a respective snippet of code that, when executed, generates the respective response by following the sequence of actions specified by the response trajectory;
generating, for each query and for each response trajectory generated for the query, a training example, wherein the training example comprises the respective snippet of code for the response trajectory and the query; and
training a generative neural network on the training examples.
